(19) United States
(12) Patent Application Publication
(10) Pub. No.: US 2008/0160366 A1
(43) Pub. Date: Jul. 3, 2008

(54) POROUS PLATE FOR A FUEL CELL

(76) Inventors: Glenn M. Allen, Vernon, CT (US); Gennady Resnick, South Windsor, CT (US)

Correspondence Address: CARLSON, GASKEY & OLDS, P.C., 400 WEST MAPLE ROAD, SUITE 350, BIRMINGHAM, MI, 48009, US

(21) Appl. No.: 11/617,999

(22) Filed: Dec. 29, 2006

(51) Int. Cl. H01M 2/16

(52) U.S. Cl. 429/20; 429/39

(57) ABSTRACT

In one example, a fuel cell utilizes a non-carbonized, non-graphitized porous polymer water transport plate having a water permeability of less than 30×10⁻¹⁷ m². The water transport plate is part of a fuel cell that employs an evaporative cooling loop. In one example, the water transport plate has a bubble pressure of less than 5 psig. The water transport plate is less costly and easier to manufacture.

### BACKGROUND OF THE INVENTION

This invention relates to a porous plate suitable for a fuel cell that utilizes evaporative cooling, for example.

One type of fuel cell includes a proton exchange membrane (PEM) sandwiched between a cathode and an anode. In a PEM fuel cell, a hydrogen-containing fuel and an oxidizer are directed to opposite sides of the membrane, typically by way of reactant passageways and/or gas diffusion layers, as is known. A separator plate prevents commingling of the reactant gases. Product water is formed by an electrochemical reaction on a cathode side of the fuel cell, and the product water must be drawn away from the cathode side of the cell or it will block the passages to the electrochemical reaction sites, known as flooding.

Additionally, in a typical PEM fuel cell having a solid polymer electrolyte membrane, the heat of the electrochemical reaction tends to dehydrate the membrane, thereby increasing electrical resistance and decreasing performance. A critical challenge when operating a fuel cell is to keep the membrane humidified. Typically, makeup water must be provided to the cell in an amount that will prevent the proton exchange membrane from drying out. The makeup water may be provided through external or internal humidification of the reaction gases. Coolant water is used to control the temperature of the fuel cell. Both the coolant water and product water must be managed to achieve desired operation of the fuel cell.

One type of fuel cell utilizes a thermal management system known as total water management (TWM). A TWM system utilizes a porous separator plate, commonly known as a water transport plate (WTP). In one configuration, reactant gas flows through channels on one side of the plate and circulating coolant water flows on the other side. The pores in the plate are sized such that the capillary pressure of the water in the pores prevents reactant gas from crossing the plate to the coolant stream, creating a wet seal, yet allows liquid transfer across the plate if subjected to a pressure differential. The cooling water is maintained at a sub-ambient pressure to pull the product water into the coolant stream. On the anode plate, the pores are sized to allow the sub-ambient coolant to pass through the plate and humidify the membrane. Thus, product water removal and membrane humidification are efficiently accomplished. The circulating coolant removes heat from the electrochemical reaction to keep the fuel cell at a controlled temperature. The flow and water balance is controlled by a pump, for example, and other components.

Two important performance characteristics of the water transport plate are bubble pressure and water permeability. Bubble pressure is the physical characteristic that allows the water transport plate to serve as a gas separator. As defined herein, bubble pressure means the pressure needed to overcome the binding forces of a fluid in a pore structure. The bubble pressure of a porous structure can be measured by standard techniques such as ASTM F316. Bubble pressure is related to capillary pressure: capillary forces retain water within a porous structure until the gas-to-liquid pressure differential exceeds the bubble pressure. Bubble pressure generally increases as the pore size of the water transport plate is decreased.

In prior art TWM systems, the required bubble pressure is primarily a function of the coolant pressure drop from the inlet to the outlet. One component of the pressure drop is attributed to the dynamic pressure losses associated with flow through the channels. Another component is a function of current density: increasing current density consumes more water in the fuel cell, causing the coolant exit pressure to drop. Since the reactant pressures on the opposite side of the porous plate are essentially constant, the porous plate must be capable of resisting reactant gas breakthrough as the liquid coolant pressure decreases. In a TWM system, the pressure drop, and therefore required bubble pressure, is in the range of 34.5-103.4 kPa (5-15 psig).

Water permeability as defined herein means the ability of a fluid to travel through a porous medium. Water permeability can be measured by standard techniques such as ASTM E128. Water permeability is required in a porous plate to satisfy water transport requirements such as humidification and removal of product water. Water permeability generally increases as the mean pore size of the water transport is increased. Thus, bubble pressure and water permeability are opposing characteristics that must be carefully balanced through proper selection of pore size and structure.

Known total water management systems require a bubble pressure of 34.5-103.4 kPa (5-15 psig) to overcome the pressure drop of the circulating coolant loop. In those systems, a water permeability of between 20×10⁻¹⁷ m²-400×10⁻¹⁷ m² is required to effectuate proper humidification and water removal. Water permeability greater than these values would tend to transport too much water at the operating pressure differential. Water permeability less than these values would tend to transport insufficient water. Designing and manufacturing a porous plate with bubble pressure and water permeability in these ranges can be difficult and costly.

Total water management systems also typically use a water transport plate that receives a wettability treatment during manufacture in which the water transport plate is carbonized and graphitized to maximize these characteristics. These thermal treatments serve to strengthen the part and increase electrical conductivity.

What is needed is a water transport plate having characteristics that are less costly to achieve while providing desired fuel cell performance.

### SUMMARY OF THE INVENTION

A fuel cell power system includes a fuel cell having water. A cooling system provides a cooling loop fluidly connected to the fuel cell. the cooling system receiving evaporated water from the fuel cell, and including a condenser condensing the evaporated water to providing cooled water that is returned to the fuel cell. A water transport plate is arranged within the fuel cell to manage water flow within the fuel cell. One example water transport plate has a bubble pressure of less than 34.4 kPa (5 psig) and a water permeability of less than 30×10⁻¹⁷ m², although other ranges are possible.

These and other features of the present invention can be best understood from the following specification and drawings, the following of which is a brief description.

### BRIEF DESCRIPTION OF THE DRAWINGS

FIG. 1 is a schematic view of an evaporative cooling system.

FIG. 2 is a graph of pressure verses current density for an example evaporative cooling system.

### DETAILED DESCRIPTION OF THE PREFERRED EMBODIMENT

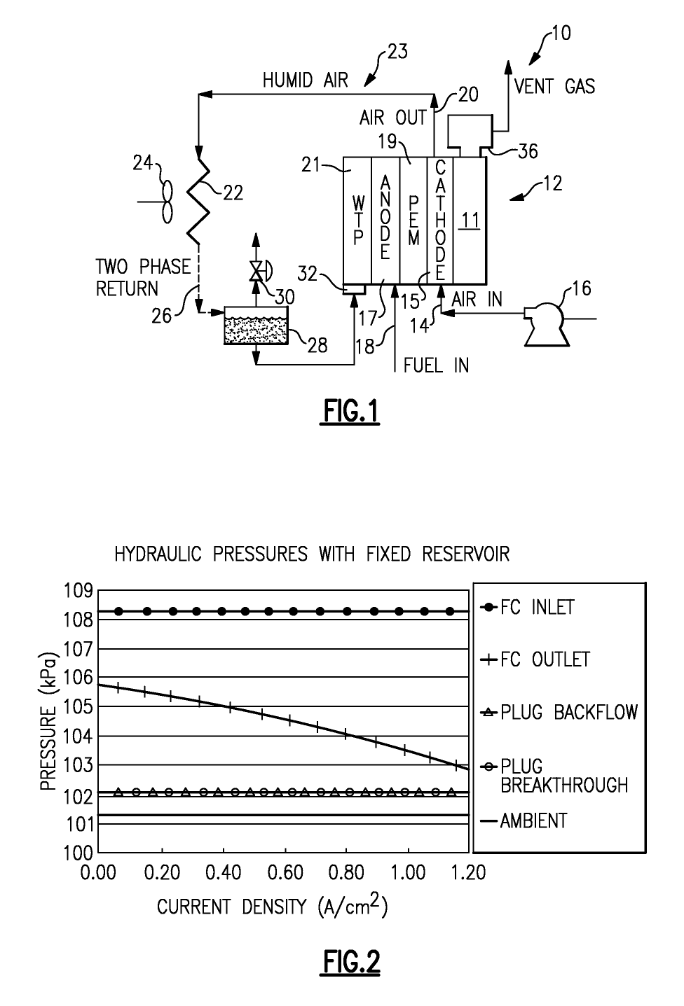

An evaporative cooling system 10 is schematically shown in FIG. 1. The system 10 includes a fuel cell 12 that receives air through an air inlet 14 to a cathode 15. The air is delivered to the cathode 15 using a blower 16, for example. A proton exchange membrane 19 is arranged between the cathode 15 and an anode 17 to form a cell 11 arranged in a stack, as is known in the art. Another cell 11 is shown schematically in the stack. The anode 17 receives hydrogen from a fuel inlet 18.

The fuel cell 12 includes coolant water and product water, which is produced as part of the electrochemical reaction within the fuel cell. Separator plates, such as water transport plates 21, are arranged within the fuel cell 12 having at least one porous section to manage and move the water in a desired manner, as is known. In one example, the porous section is wettable. The evaporative cooling system 10 employs an evaporative cooling loop 23 as part of the fuel cell's thermal management system. Water formed as a byproduct of the electrochemical reaction, as well as water passing through the membrane 19 by proton drag, is evaporated off the cathode electrode 15 and into the cathode air stream (shown schematically arranged between the air inlet 14 and air outlet 20) where it exits the fuel cell 12 into the evaporative cooling loop 23.

The cathode 15 produces liquid product water that generates water vapor or humid air. Humid air exits the fuel cell 12 through an air outlet 20, and circulates to a condenser 22 that condenses the humid air with the assistance of a fan 24, as is known in the art. A two phase mixture of coolant water and air that leaves the condenser 22 and circulates to a reservoir 28 where the coolant water collects. The gas ingested by the evaporative cooling loop 23 is expelled through a back pressure valve 30, which controls the coolant inlet pressure. The coolant water flows from the reservoir 28 to a coolant inlet 32 into the fuel cell 12.

Unlike total water management systems, the evaporative cooling system 10 relies on evaporation to dispel heat rather than a pump circulating coolant water (sensible cooling). Due to the large pressure drop associated with circulating coolant water, total water management systems require a large pressure differential across the water transport plate 21, for example 34.4 kPa (5 psig) or more. By way of contrast, evaporative cooling systems require a much lower pressure differential that makes it possible to use water transport plates having a bubble pressure and water permeability different from prior art water transport plates, which will be appreciated from the following example.

FIG. 2 illustrates typical coolant pressures at the inlet and outlet of the fuel cell as a function of current density. In the example shown, coolant water is supplied from a constant pressure reservoir at 108 kPa, which is 8 kPa above ambient pressure. The pressure at the coolant outlet, or air outlet 20, decreases with increasing current density because the flow of coolant water into the cell increases. The coolant outlet pressure must remain above the line marked “plug back flow” in FIG. 2 to prevent gas from entering the fuel cell vent through the gas separator 36.

The air and fuel pressures must be above the coolant inlet pressure at coolant inlet 32 to prevent water from flowing into the air and fuel flow fields within the cathode 15 and anode 17, respectively, from the water transport plates 19. As a result, the fuel and air pressures must exceed 108 kPa in the illustrated example. If the gas pressures are essentially constant, then the minimum required bubble pressure is found by subtracting the coolant outlet pressure from the gas pressure. For example, if the gas pressures are 109 kPa, then the bubble pressure must be roughly 109−103=6 kPa (0.87 psig) to allow operation to a current density of 1.2 a-cm². Thus, a much lower bubble pressure is needed for an evaporative cooling system as compared to a total water management system.

One example minimum required bubble pressure for an evaporatively cooled stack may be ascertained by determining the pressure of a column of coolant equal to the height of the wet seal. The difference between the coolant inlet and coolant outlet pressures at a current density of zero a/cm² is the static head induced by the height of the wet seal according to the calculation p=ρgh (where ρ is the density of the coolant, g is the gravitational constant, and h is the wetted height). Wetted height is defined as the vertical height to which a wet seal must be maintained. Wet seal is defined as a porous section, which, when wetted, will allow liquid to pass through, but not gas. Assuming a wetted stack height of 0.25 m yields a stack head, and thus minimum required bubble pressure, of 2.5 kpa (1,000 kg-m³×9.81 m/kg×0.25 m), or 0.36 psig. Prior art fuel cells utilizing sensible cooling would have required a minimum bubble pressure significantly higher than the ρgh value or else reactant gas would have broken through the wet seal into the coolant flow field.

The coolant outlet pressure line curve is determined by the design of the coolant flow fields. Since the coolant water flow rates are very low (4.5 cc/min at 1 A/cm²) a flow field with channel depths typically around 0.4 mm will give very low pressure drops and the coolant outlet pressure will be essentially constant as a function of current density. As a result, the coolant outlet pressure is approximately 2.5 kpa below the coolant inlet pressure at all current densities, which gives the minimum bubble pressure.

As can be appreciated from the above example, the minimum bubble pressure for a water transport plate can be considerably less than a total water management system, for example between 0-34.5 kPa (0-5 psig).

In one example, the water transport plates 21 are made of a graphite and phenolic resin composite. The graphite can be bound in other manners. The local wetting or contact angle of the water transport plate is unknown and variable so that pore size alone does not determine the bubble pressure. Since the wetting angle is unknown and assumed to be zero, the bubble pressure is considered the more fundamental water transport plate characteristic (the combination of pore size and wetting angle determines bubble pressure). The maximum pore diameter can be higher (20 microns; 3.6 microns in one example) as well as the porosity (15% by volume; 28% by volume in one example).

The water permeability requirements may be different from prior art systems utilizing sensible cooling. In one example evaporatively-cooled fuel cell, the cathode separator plate has reduced porosity because it is only required to humidify the cathode reactant stream and is not required to transport cathode product water. As a result, the water permeability can be lower (less than 30×10⁻¹⁷ m², and in some examples 5×10⁻¹⁷ m²) and still achieve desired fuel cell performance. In another example evaporatively-cooled fuel cell, the cathode separator plate is solid. The corresponding porous anode separator plate must satisfy all water transport requirements for the fuel cell. As a result, the water permeability can be higher (greater than 2,000×10⁻¹⁷ m², and in some examples 5,000×10⁻¹⁷ m²) and still achieve desired fuel cell performance. In both examples, there is no upper limit to the corresponding bubble pressure because only a minimum bubble pressure is required to maintain the wet seal. A practical upper limit on the bubble pressure is the pressure at which other features of the plate, such as seals, will fail. Experiments have indicated this pressure to be approximately 149.6 kPa (21.7 psig).

The saturation of the resulting water transport plate 21 is less than 100% and unknown. Thus, water permeability must be measured experimentally. The through-plane resistivity of the example water transport plates described above has been in above 0.04 ohm-cm, and in the range of 0.10-0.12 ohm-cm. One example maximum through-plane resistivity is 0.25 ohm-cm.

Although a preferred embodiment of this invention has been disclosed, a worker of ordinary skill in this art would recognize that certain modifications would come within the scope of this invention. For that reason, the following claims should be studied to determine the true scope and content of this invention.

1. A fuel cell power system comprising:
a fuel cell configured to transport water;
a cooling system providing a cooling loop fluidly connected to the fuel cell, the cooling system receiving evaporated water from the fuel cell, and including a condenser configured to condense the evaporated water to provide cooled water that is returned to the fuel cell; and
a water transport plate arranged within the fuel cell to manage water flow within the fuel cell, the water transport plate having a bubble pressure of less than 34.5 kPa.

2. The fuel cell power system according to claim 1, wherein the water transport plate includes a water permeability of approximately 5×10⁻¹⁷ m² -5000×10⁻¹⁷ m².

3. The fuel cell power system according to claim 2, wherein the water transport plate includes a water permeability of greater than 2000×10⁻¹⁷ m².

4. The fuel cell power system according to claim 1, wherein the water transport plate includes a maximum pore size diameter of 20 microns.

5. The fuel cell power system according to claim 4, wherein the water transport plate includes a maximum pore size diameter of 3.6 micron.

6. The fuel cell power system according to claim 1, wherein the water transport plate includes a porosity of at least 15% by volume.

7. The fuel cell power system according to claim 7, wherein the porosity is less than 30% by volume.

8. A porous body for use in a fuel cell comprising:
a plate including at least one porous portion having a water permeability of greater than 2000×10⁻¹⁷ m².

9. The porous body according to claim 8, comprising graphite.

10. The porous body according to claim 8, comprising a maximum through plate resistivity of greater than 0.04 ohm-cm and less than approximately 0.25 ohm-cm.

11. The porous body according to claim 8, comprising a bubble pressure of 0-149.6 kPa.

12. The porous body according to claim 11, comprising a bubble pressure of less than 34.5 kPa.

13. The porous body according to claim 8, comprising a maximum pore size diameter of 20 microns.

14. The porous body according to claim 8, comprising a porosity of at least 15% by volume.

15. The porous body according to claim 14, comprising a porosity of less than 30% by volume.

16. A porous body for use in a fuel cell, comprising a plate including at least one porous section, said porous section having a bubble pressure from about ρgh to about 34.5 kPa.

17. The porous body of claim 16, wherein said porous section has a water permeability in the range of about 5×10⁻¹⁷ m² to about 5,000×10⁻¹⁷ m².

18. The porous body of claim 16, wherein said porous section has a maximum through plate resistivity of greater than 0.04 ohm-cm and less than approximately 0.25 ohm-cm.

19. The porous body of claim 17, wherein said porous section has a maximum pore size diameter of 20 microns.

20. The porous body of claim 17, wherein said porous section has a porosity of at least 15% by volume.

21. The porous body of claim 20, wherein said porous section has a porosity of less than 30% by volume.
